(19) United States
(12) Patent Application Publication
(10) Pub. No.: US 2008/0058004 A1
(43) Pub. Date: Mar. 6, 2008

(54) SYSTEM AND METHOD FOR REASSIGNING AN UPLINK TIME SLOT FROM A CIRCUIT-SWITCHED GPRS MOBILE DEVICE TO A DIFFERENT PACKET-SWITCHED GPRS MOBILE DEVICE

(75) Inventors: ILYA O. GONOROVSKY, EAST BRUNSWICK, NY (US); STEPHEN A. HOWELL, GLOUCESTER (GB); JIAN J. WU, READING (GB)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/831,071

(22) Filed: Jul. 31, 2007

Related U.S. Application Data
(63) Continuation-in-part of application No. 11/514,409, filed on Aug. 29, 2006.

(51) Int. Cl. H04Q 7/20

(52) U.S. Cl. 455/552.1

(57) ABSTRACT

A wireless communication system (100) includes a first mobile device (110) with a circuit-switched connection using adaptive multi-rate (AMR) speech coding. This first mobile device (110) is assigned to a first time slot by a base station (130). The base station (130) also serves at least a second mobile device (120) with a packet-switched connection and assigned to a second time slot. The base station (130) instructs the second mobile device (120) to transmit data on the first time slot, as well as its originally-assigned second time slot, during a no-speech-data AMR frame of the first mobile device (110). The base station ceases to instruct the second mobile device (120) to transmit data on the first time slot when it receives an AMR Access Burst (AAB) from the first mobile device (110). A 52-multiframe structure, used by the second mobile device (120) when it is transmitting on the first time slot, includes at least one A-idle frame when the first mobile device (110) can transmit its AAB.

### CROSS REFERENCE TO RELATED APPLICATIONS

This application is related to U.S. patent application Ser. No. 11/514,409 filed on Aug. 29, 2006 by Gonorovsky et al and entitled “System for Combining Uplink Data Blocks from a User with Transmission Pauses from another User.” The related application is assigned to the assignee of the present application and is hereby incorporated herein in its entirety by this reference thereto.

### FIELD OF THE DISCLOSURE

This disclosure relates generally to uplink packet utilization in a GSM/EDGE (Global System for Mobile communications/Enhanced Data rate for GSM Evolution) radio access network used in General Packet Radio Service (GPRS) and Enhanced GPRS (EGPRS) wireless communication systems.

### BACKGROUND OF THE DISCLOSURE

General Packet Radio Service (GPRS) is a mobile data service available to users of GSM mobile phones. GPRS provides moderate speed data transfer by using TDMA channels in the GSM network. EDGE is an advanced GPRS system protocol that can be used for any packet switched application—such as an Internet connection. High-speed data applications such as video services and other multimedia benefit from increased data capacity.

Adaptive Multi-Rate (AMR) is an audio data compression scheme optimized for speech coding. AMR is adopted as the standard speech codec by 3GPP TS 26.093. The codec has eight bit rates, 12.2, 10.2, 7.95, 7.40, 6.70, 5.90, 5.15 and 4.75 kbit/s. The bitstream is based on AMR frames, which contain 160 samples and are sent every 20 milliseconds. AMR uses different techniques, such as Algebraic Code Excited Linear Prediction (ACELP), Discontinuous Transmission (DTX), voice activity detection (VAD), and comfort noise generation (CNG).

When using a mobile device to transmit AMR-encoded speech, an AMR module will transmit no speech data when the speaker pauses during speech. The AMR frames with no speech data can be replaced with data blocks from a packet-switched application running on the same device if that mobile device supports dual transfer mode (DTM). The premise for DTM is that a circuit-switched (CS) connection, such as a speech telephone call, and a packet-switched (PS) connection, such as an Internet session, are activated simultaneously on the same wireless device—which is not a frequent situation.

Assuming that the average time duration for the pauses from each participant in a two-person speech conversation is about fifty percent, it would be very desirable if a GSM/EDGE Radio Access Network (GERAN) would allow use of no-speech-data AMR frames during the pauses from one user to be filled with uplink data blocks from another user. Such reuse would enable significant increases in capacity for GERAN systems in the uplink direction. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a simplified diagram of a GPRS or EGPRS wireless communication system.

FIG. 2 shows a prior art example of standard AMR frames (taken from 3GPP TS 26.093 Section 5.1.2.1 FIG. 3).

FIG. 3 shows a prior art standard GPRS or EGPRS 52-multiframe used for data transfer.

FIG. 4 shows an AMR Access Burst in accordance with the embodiments.

FIG. 5 shows a GPRS or EGPRS 52-multiframe as used for data transfer on the time slot of reassigned no-speech-data AMR frames in accordance with a first embodiment.

FIG. 6 shows a GPRS or EGPRS 52-multiframe as used for data transfer on the time slot of reassigned no-speech-data AMR frames in accordance with a second embodiment.

FIG. 7 is a flowchart of a method for a GPRS or EGPRS base station to reassign the time slot of one mobile device's no-speech-data AMR frames to another mobile device's packet-switched data.

FIG. 8 is a flowchart of a method for a mobile device with a circuit-switched connection to assist its serving base station to reassign the time slot of its no-speech-data AMR frames to another mobile device's packet-switched data.

FIG. 9 is a flowchart of a method for a GPRS or EGPRS mobile device to transmit packet-switched data on the time slot of another mobile device during the no-speech-data AMR frames of the other mobile device.

### DETAILED DESCRIPTION

A wireless communication system includes a first mobile device with a circuit-switched connection using adaptive multi-rate (AMR) speech coding. This first mobile device is assigned to a first time slot by a base station. The base station also serves at least a second mobile device with a packet-switched connection and assigned to a second time slot. The base station instructs the second mobile device to transmit data on the first time slot, as well as its originally-assigned second time slot, during a no-speech-data (N) AMR frame of the first mobile device. The base station ceases to instruct the second mobile device to transmit data on the first time slot when it receives an AMR Access Burst (AAB) from the first mobile device. A 52-multiframe structure, used by the second mobile device when it is transmitting on the first time slot, includes at least one A-idle frame during which the first mobile device can transmit its AAB.

By allowing a second mobile device to transmit data blocks on a first time slot when N AMR frames are expected increases the data throughput of the second mobile station and the data capacity of the base station and GPRS network as a whole. Although sometimes GPRS and EGPRS are explicitly mentioned, because EGRPS is an evolution of GPRS, the discussion of GPRS in the Detailed Description will implicitly include EGPRS and the discussion of EGPRS will implicitly include GPRS.

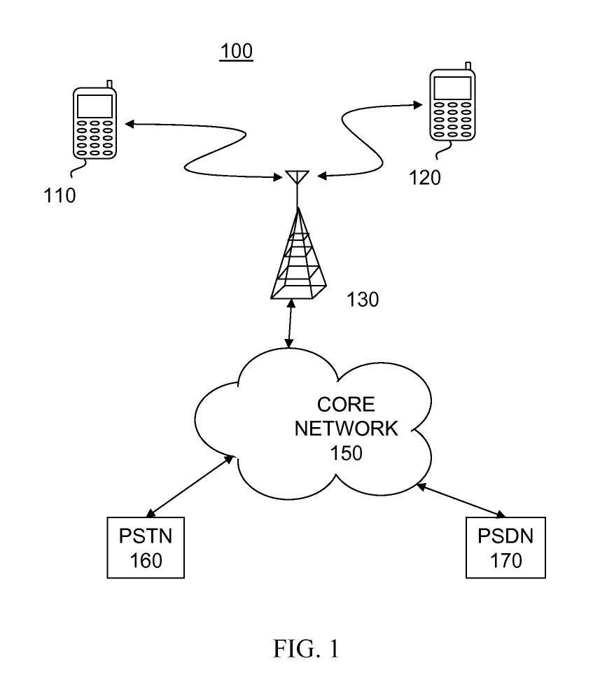

FIG. 1 shows a simplified diagram of a GPRS or EGPRS wireless communication system 100. The system 100 includes a first mobile device 110 that has a circuit-switched (CS) connection, a second mobile device 120 that has a packet-switched (PS) connection, a base station 130 serving both the first mobile device 110 and the second mobile device 120, a core network 150 in communication with the base station 130, as well as a Public Switched Telephone Network (PSTN) 160 and a Public Switched Data Network (PDSN) 170. Many other elements, such as additional mobile devices, additional base stations, base station controllers, and devices within and connected to the core network have been omitted for the sake of clarity.

The first mobile device 110 communicates wirelessly to its serving base station 130 on its assigned first time slot using AMR speech coding. The voice information is routed through the core network 150 to the PSTN 160 to support a telephone call.

The second mobile device 120 communicates wirelessly to its serving base station 130 on its assigned second time slot using a packet-switched connection through the core network 150 to the PSDN 170, which may be part of the Internet or connected to an intranet.

In this configuration, the base station 130 can re-assign to the second mobile device 120 the first time slot of the first mobile device 110 when there are no-speech-data (N) AMR frames expected from the first mobile device 110. This provides the second mobile device 120 with increased data capacity from the unused bandwidth of the first mobile device 110. Because speech data of a circuit-switched connection has strict latency requirements, when the user of the first mobile device 110 resumes talking during the telephone conversation, the base station 130 will assign the wireless resources back to the first mobile device 110 at the very next AMR (voice) frame—even if it is in the middle of a 52-multiframe used for data transfer over the first time slot by the second mobile device 120.

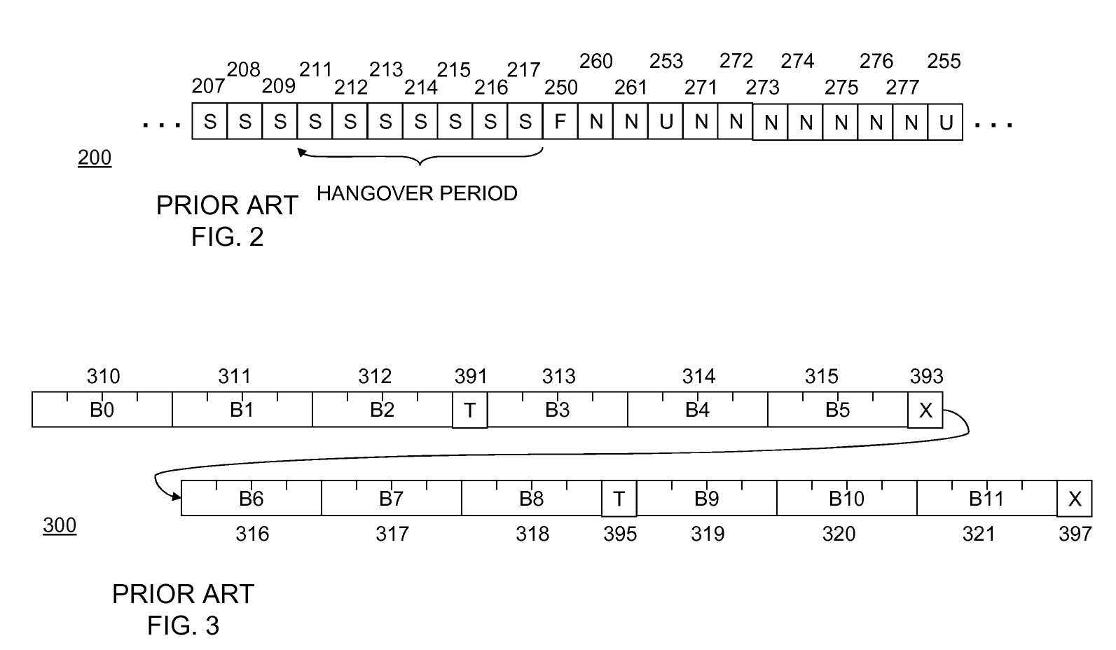

FIG. 2 shows a prior art example of standard AMR frames 200 (taken from 3GPP TS 26.093 Section 5.1.2.1 FIG. 3). These AMR frames 200 could be transmitted by the first mobile device 110 shown in FIG. 1 over an assigned first time slot that recurs every 20 milliseconds. Each AMR frame may contain either speech data (S), silence descriptor data (F and U), or no-speech-data (N). The speech data AMR frames (S) can be conceptually divided into “actual” speech AMR frames 207, 208, 209 and “hangover” speech AMR frames 211, 212, 213, 214, 215, 216, 217. The seven-AMR-frame hangover period gives the AMR codec time to analyze the background noise of the telephone call and update a silence descriptor (SID). The SID is included in the SID First (F) AMR frame 250 after the hangover period and conveys information about the acoustic background noise of the telephone call (“comfort noise”).

After the F AMR frame 250, N AMR frames 260, 261, 271, 272, 273, 274, 275, 276, 277 can be transmitted interrupted periodically by SID Update (U) AMR frames 253, 255 until the user starts talking and S AMR frames resume (not shown). The N AMR frames convey no information. If the mobile device has a simultaneous packet-switched connection, dual-transfer mode (DTM) can be used to during N AMR frames to transmit packet data. But if the mobile device does not have a simultaneous packet-switched connection (which is a common use case), wireless resources are wasted during N AMR frames.

By reassigning the time slot of N AMR frames of one mobile device (such as the first mobile device 110 shown in FIG. 1) to another mobile device (such as the second mobile device 120 shown in FIG. 1) being served by the same base station (such as base station 130 shown in FIG. 1), the data throughput of the second mobile device can be increased with little impact on the voice call of the first mobile device.

FIG. 3 shows a prior art standard GPRS or EGPRS 52-multiframe 300 as used for data transfer. Note that the 52 frames within a GPRS 52-multiframe 300 do not have the same characteristics of an AMR frame despite the common nomenclature “frame.” In fact, the recurrence of an AMR frame (20 milliseconds) is equivalent to one GPRS data block rather than one GPRS frame.

The 52-multiframe 300 is broken into three consecutive GPRS data blocks 310, 311, 312 (made of four GPRS frames). Next comes a mandatory T frame 391 used for Packet Timing Control Channel (PTCCH) information. Three more GPRS data blocks 313, 314, 315 follow and then a mandatory X-idle frame 393. Then follows three more GPRS data blocks 316, 317, 318 and another T frame 395 and a final three GPRS data blocks 319, 320, 321 and another X-idle frame 397.

In order to allow the first mobile device to resume AMR frames soon after the user starts speaking again (which is at an arbitrary time), it is important to allow the first mobile device to let the base station know that AMR frames are needed even while the second mobile device is in the middle of a 52-multiframe uplink transmission.

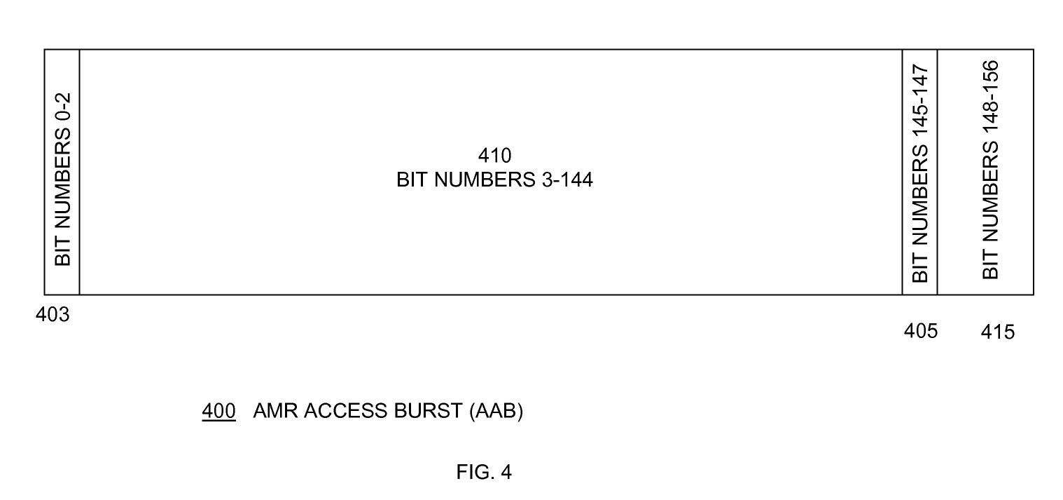

FIG. 4 shows an AMR Access Burst (AAB) 400 in accordance with the embodiments. The AAB 400 allows the first mobile device to indicate to its serving base station (e.g., base station 130 in FIG. 1) that AMR (voice) frames have re-started and therefore the first time slot is needed by the first mobile device to transmit AMR frames. When an AAB is received by a base station, it discontinues its reassignment of the first time slot to the second mobile device.

Within the AAB 400 is three initial tail bits 403, a fixed number of bits 410, three final tail bits 405, and a variable number of guard bits 415. The tail bits 403, 405 at either end of the fixed number of bits 410 delimit the beginning and end of the fixed number of bits 410 and assist in the equalization of the data message portion of the signal. The tail bits are defined as modulating bits with states as follows:
(BN0, BN1, BN2)=(0, 0, 0) and
(BN145, BN146, BN147)=(0, 0, 0).
   The fixed bits 410 are defined as modulating bits containing AAB signal information, with states as follows:
(BN3, BN4, . . . , BN144)=(0, 0, . . . , 0)

The AAB 400 is selected to be an uplink replica of the Frequency Correction Burst (FCB), which is used only in the downlink direction in GERAN networks. If a Compact FCB is used in the downlink direction, the counterpart AAB is easily modified to have “fixed bits” 410 contain the following states:
(BN3, BN4, BN5, BN6 . . . , BN143, BN144)=(1, 0, 1, 0, . . . , 1, 0).

The variable number of guard bits 415 of the AAB 400 is conventional. In a GERAN system, the synchronization of mobile devices is achieved by sending timing advance commands from the serving base station that instruct the mobile devices to transmit earlier and by how much. This compensates for propagation delay between a particular mobile device and its serving base station. The mobile device is not allowed to transmit for its entire timeslot, because there is a guard interval at the end of each timeslot. If a transmission moves into the guard period, the mobile network adjusts the timing advance to synchronize the transmission.

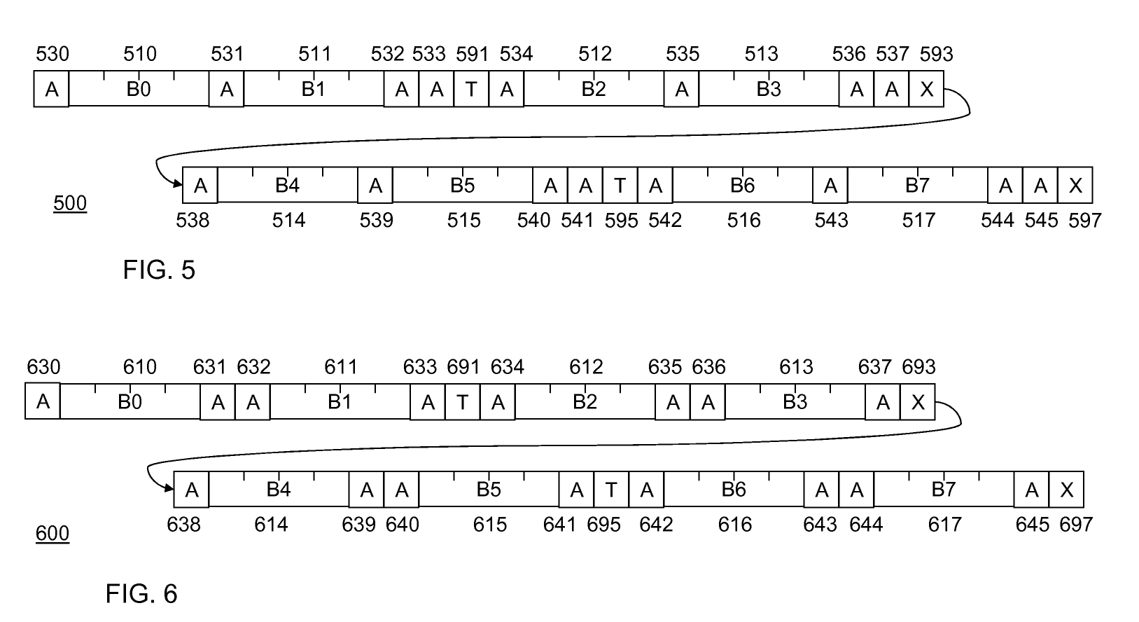

FIG. 5 shows a GPRS or EGPRS 52-multiframe 500 as used for data transfer on the time slot of reassigned no-speech-data AMR frames in accordance with a first embodiment. This 52-multiframe 500 can accommodate up to eight GPRS data blocks 510, 511, 512, 513, 514, 515, 516, 517, sixteen A-idle frames 530, 531, 532, 533, 534, 535, 536, 537, 538, 539, 540, 541, 542, 543, 544, 545, the two mandatory T frames 591, 595 of a 52-multiframe, and the two mandatory X frames 593, 597 of a 52-multiframe.

The A-idle frames provide the first mobile device a time period with which to transmit an AAB (see AAB 400 in FIG. 4) when the user of the first mobile device resumes speaking. There is at least one A-idle frame before and after each data block 510, 511, 512, 513, 514, 515, 516, 517, each mandatory T frame 591, 595, and each mandatory X frame 593, 597. This means that after any GPRS data block, T frame, or X frame is transmitted by a second mobile device when it is using a first time slot during no-speech-data AMR frames of a first mobile device, there is one GPRS frame time period for the first mobile device to transmit an AAB (see AAB 400 in FIG. 4). By structuring the 52-multiframe 500 in this manner, the first mobile device will never have to delay an AAB for more than four GPRS frames (equivalent to one GPRS data block or 20 milliseconds).

Because the placement of the T frames 591, 595 and the X frames 593, 597 within a 52-multiframe are mandatory, there are additional opportunities to include A-idle frames. In this first embodiment, the additional A-idle frames 533, 537, 541, 545 are placed immediately prior to the T frames 491, 495 and the X frames 493, 497 in the 52-multiframe.

FIG. 6 shows a GPRS or EGPRS 52-multiframe 600 as used for data transfer on the time slot of reassigned no-speech-data AMR frames in accordance with a second embodiment. In this second embodiment, the additional A-idle frames 632, 636, 640, 644 are located so that there are at least two A-idle frames 631, 631, 632, 633, 634, 635, 636, 637, 638, 639, 640, 641, 642, 643, 644, 645 frames between each data block 610, 611, 612, 613, 614, 615, 616, 617. Meanwhile, this 52-multiframe 600 still honors the mandatory placement of the T frames 691, 695 and the X frames 693, 697 within a 52-multiframe.

Alternate 52-multiframes can be structured such that the mandatory placement of the T frames and X frames are maintained while also allowing GPRS data blocks from a second mobile device to be sent on a first time slot of a first mobile device during the no-speech-data AMR frames of the first mobile device. Although the 52-multiframes 500, 600 shown in this Detailed Disclosure have no more than four GPRS frames between A-idle frames, it is possible to have more than four GPRS frames between A-idle frames if an increased AMR latency is acceptable.

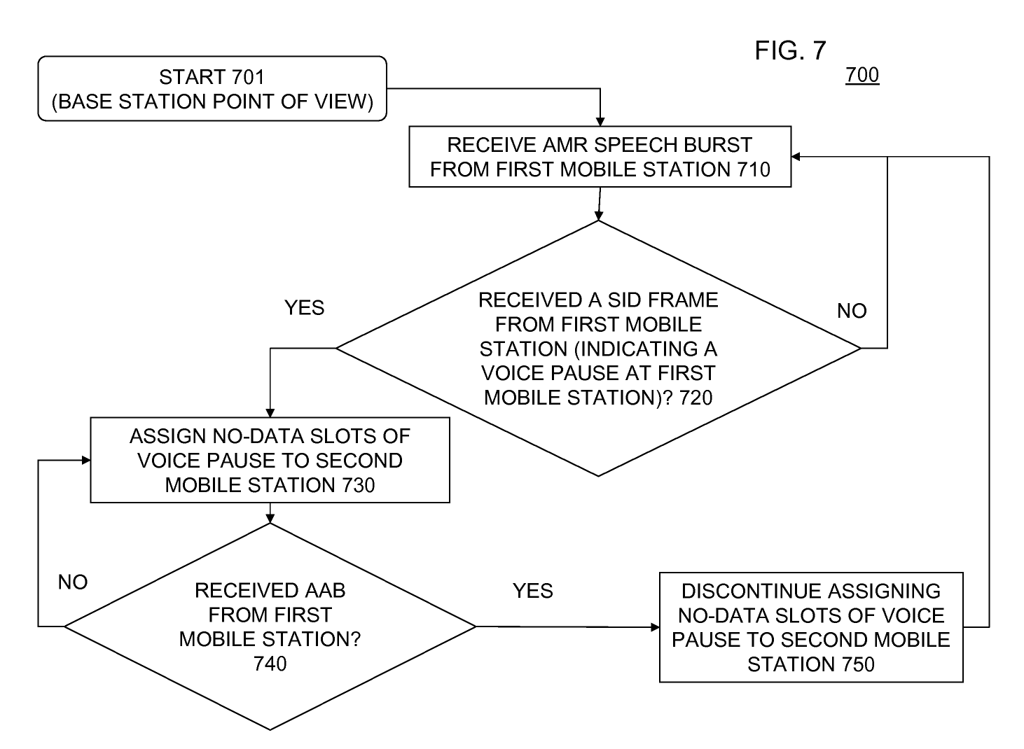

FIG. 7 is a flowchart 700 of a method for a GPRS or EGPRS base station to reassign the time slot of one mobile device's no-speech-data (N) AMR frames to another mobile device's packet-switched data. Because the base station (such as base station 130 in FIG. 1) serves both the first mobile device (such as the first mobile device 110 shown in FIG. 1) and the second mobile device (such as the second mobile device 120 shown in FIG. 1), it knows the GPRS frame numbers and 52-multiframe numbers for each of its served mobile devices—which are all synchronized.

When the flowchart 700 starts 701 at the base station, the base station receives 710 an AMR speech burst from a first mobile device on a first time slot that had been assigned to the first mobile device. The AMR speech burst will last for a number of S AMR frames (such as S AMR frames 207, 208, 209 shown in FIG. 2). As long as no F AMR frame is received 720 (see F AMR frame 250 in FIG. 2), the AMR speech burst continues to be received 710.

If an F AMR frame is received 720, the base station assigns the first time slot, which is receiving no-speech-data (N) AMR frames (see N AMR frames 260, 261, 271, 272, 273, 274, 276, 276, 277) of the voice pause on the first mobile device, to the uplink data blocks of a second mobile device. Each uplink data block from the second mobile device can be individually controlled by the base station using header information, and the base station can assign the first time slot to the second mobile device on a block-by-block basis as long as no AAB (see AAB 400 in FIG. 4) is received 740 by the base station from the first mobile device.

If an AAB is received 740 by the base station from the first mobile device during an A-idle frame of a 52-multiframe 500, 600, the base station immediately discontinues 750 the reassigning of the first time slot corresponding to N AMR frames from the first mobile device and returns to receiving 710 speech (S) AMR frames from the first mobile device on the first time slot. Note that the first mobile device always has priority on its own time slot. The reassignment of the first mobile device's time slot during N AMR frames allows the base station to supplement the second mobile device's existing packet-switched connection with some additional data throughput taken from unused wireless resources of the first mobile device. Also, there need not be only one “second mobile device.” If there are multiple other mobile devices with packet-switched connections being served by the base station, the base station may choose to divide the time slot of the N AMR frames among any number of these other mobile devices. Because the 52-multiframes are all synchronized across one base station and its served mobile devices, and data blocks can be assigned individually by the base station, the base station has complete control over its allocation of a first mobile device's N AMR frame time slots to the data blocks of one or more “second mobile devices.”

Because SID Update AMR frames are sent every eighth AMR frame (see U AMR frames 253, 255 in FIG. 2), the base station can give priority to the U AMR frames from the first mobile device and not re-assign a first time slot to a second mobile device when a U AMR frame is expected from the first mobile device. Unfortunately, the frequency of U AMR frames decreases the opportunities for the base station to re-assign time slots to a second mobile device. To alleviate this, the first mobile device may be instructed by the base station to only send U AMR frames 253, 255 when they coincide with A-idle frames within the 52-multiframe 500, 600. Another option is to omit sending U AMR frames and only send a SID First AMR frame (F AMR frame 250 shown in FIG. 2). Again, because the base station is aware of timing of the U AMR frames, the timing of the 52-multiframes, and packet-switched connections of other mobile devices, the base station is capable of controlling the use of the AMR frames based on a variety of factors such as maintaining U AMR frames intact, maintaining U AMR frames only on an opportunistic basis, increasing the data throughput of the second mobile device, and/or other factors and the relative priorities of the factors.

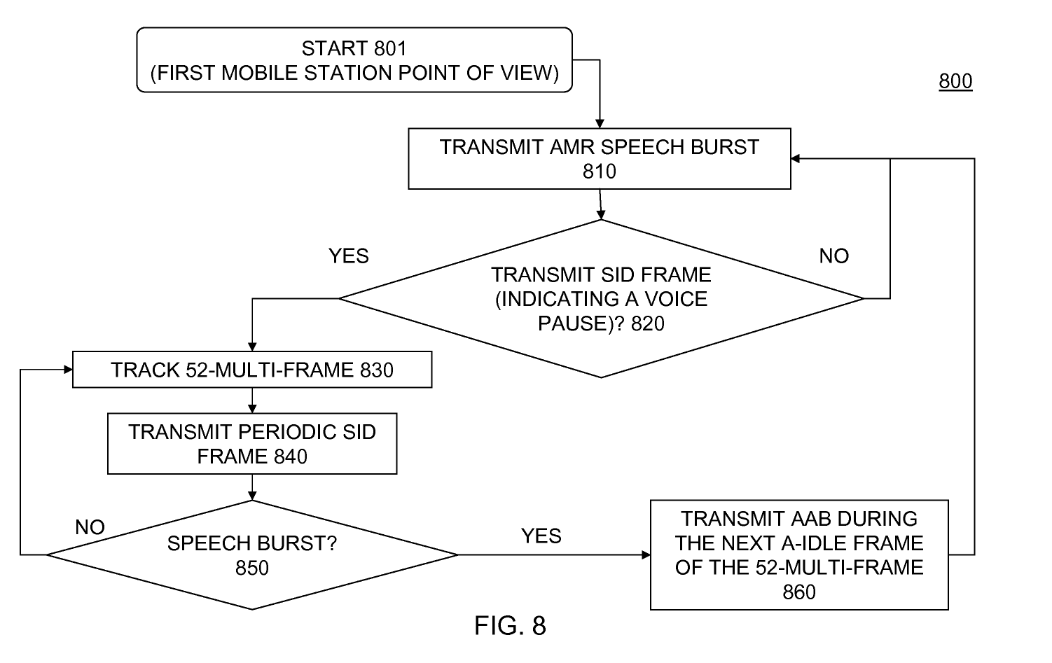

FIG. 8 is a flowchart 800 of a method for a mobile device with a circuit-switched connection to assist its serving base station to reassign the time slot of its no-speech-data (N) AMR frames to another mobile device's packet-switched data. Upon starting 801, the mobile device (such as first mobile device 110 shown in FIG. 1) transmits 810 speech AMR frames (see S AMR frames 207, 208, 209 in FIG. 2). After a hangover period (during which S AMR frames 211, 212, 213, 214, 214, 216, 217 of FIG. 2 are still being transmitted), the mobile device transmits 820 an SID First AMR frame (see F AMR frame 250 in FIG. 2).

After an F AMR frame is transmitted 820, the mobile device tracks 830 the 52-multiframe. Because all the mobile devices served by a base station are synchronized, the mobile device is aware of the starting points and structure of the 52-multiframes even when it is not transmitting packet-switched data.

Assuming that the SID Update (U) AMR frames (see U AMR frames 253, 255 of FIG. 2) will be sent every eighth AMR frame as is presently required by 3GPP TS 26.093, the mobile device transmits 840 its U AMR frame every eight AMR frames. If no speech burst is detected 850 from the user of the mobile device, the mobile device continues to track 830 the 52-multiframes.

If the frequency of SID Update AMR frames is modified, then the U AMR frames may be transmitted based on the modified frequency. For example, the U AMR frames may be transmitted only when they coincide with an A-idle frame of the 52-multiframe or the U AMR frames may be omitted altogether.

If a speech burst is detected 850 by the mobile device, the mobile device transmits 860 an AAB (see AAB 400 shown in FIG. 4) during the next A-idle frame of the 52-multiframe. After that, the mobile device transmits 810 its speech burst on S AMR frames and continues as previously described.

Note that most of the steps in the flowchart 800 are conventionally performed by a mobile device when using AMR speech coding. Although tracking 830 the 52-multiframe is explicitly mentioned so that an AAB can be transmitted 760 during the next available A-idle frame after a speech burst, a mobile device would implicitly track the 52-multiframe simply because all the served mobile devices of a single base station are synchronized.

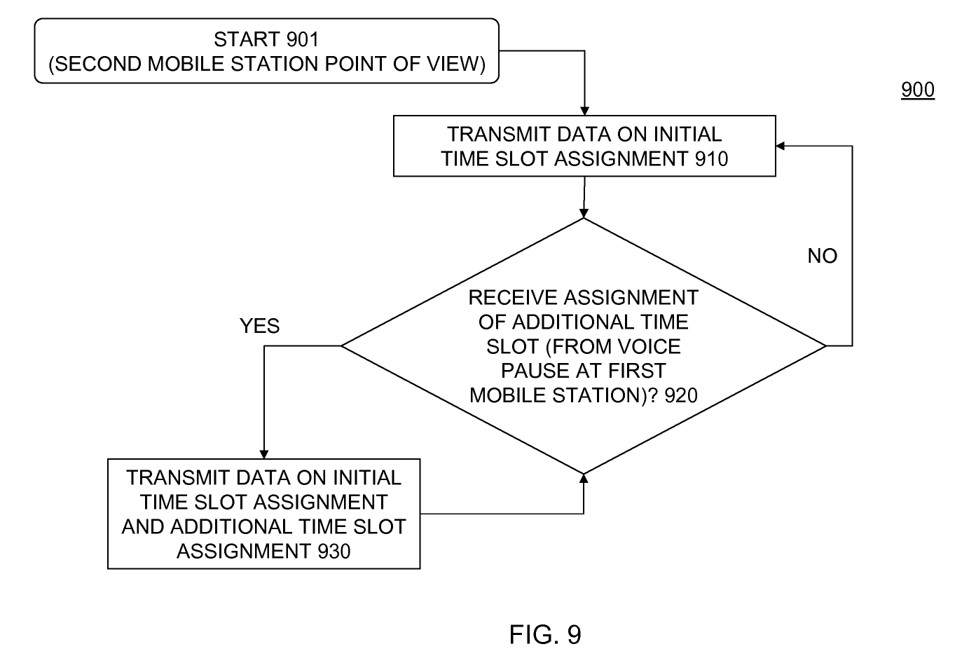

FIG. 9 is a flowchart of a method for a GPRS or EGPRS mobile device to transmit packet-switched data on the time slot of another mobile device during the no-speech-data AMR frames of the other mobile device. This mobile device is one or more second mobile devices such as the second mobile device 120 shown in FIG. 2. When the second mobile device starts 901 its packet-switched connection, it transmits 910 data on its initial time slot assignment as is customary. If the mobile device receives 920 an additional time slot assignment, which represents a reassignment of a time slot of a no-speech-data AMR frame from a different mobile device, then the mobile device transmits 930 data on the initial time slot assignment and the additional time slot assignment as directed by the base station. Otherwise, the mobile device continues to transmit 910 data only on its initial time slot assignment. Thus, there is no need to make any adjustments to the operation of the second mobile device. As usual, it transmits data as instructed by its serving base station.

Thus, a base station can reassign a first uplink time slot originally assigned to a circuit-switched connection of a mobile device that uses AMR coding. The reassignment can be to one or more mobile devices with packet-switched connections and will increase their uplink data transfer speed. When the base station receives a SID First AMR frame from the circuit-switched mobile device, it can predict the placement of future no-speech-data (N) AMR frames and SID Update (U) AMR frames. Because N AMR frames carry no information, the wireless resources (e.g., uplink time slot) of the N AMR frames can be reassigned to a packet-switched mobile device served by the same base station. A 52-multiframe for the packet-switched mobile device provides ample opportunities (e.g., A-idle frames) for the circuit-switched mobile device to inform the base station when the time slot is needed back by the circuit-switched mobile device for speech (S) AMR frames.

This method is also applicable to the downlink direction because the network knows the mobile user's information such as when the speech pause has started and when it has finished.

While this disclosure includes what are considered presently to be the embodiments and best modes of the invention described in a manner that establishes possession thereof by the inventors and that enables those of ordinary skill in the art to make and use the invention, it will be understood and appreciated that there are many equivalents to the embodiments disclosed herein and that modifications and variations may be made without departing from the scope and spirit of the invention, which are to be limited not by the embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

As understood by those in the art, controllers within each mobile device and base station include processors that execute computer program code to implement the methods described herein. Embodiments include computer program code containing instructions embodied in tangible media, such as floppy diskettes, CD-ROMs, hard drives, or any other computer-readable storage medium, wherein, when the computer program code is loaded into and executed by a processor, the processor becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

We claim:

1. A wireless communication system comprising:
a first mobile device with a circuit-switched connection using adaptive multi-rate (AMR) speech coding and assigned to a first time slot;
a second mobile device with a packet-switched connection and assigned to a second time slot; and
a General Packet Radio Service (GPRS) base station for instructing the second mobile device to transmit data on the first time slot during a no-speech-data AMR frame of the first mobile device.

2. A wireless communication system according to claim 1 wherein the second mobile device transmits data using a 52-multiframe structure having at least one A-idle frame that allows the first mobile device to transmit an AMR Access Burst (AAB) to the base station.

3. A wireless communication system according to claim 1 wherein the base station ceases to instruct the second mobile device to transmit data on the first time slot when it receives an AMR Access Burst (AAB) from the first mobile device.

4. A wireless communication system according to claim 1 wherein the base station is an EGPRS base station.

5. A wireless communication system according to claim 1 further comprising a third mobile device with a packet-switched connection and assigned to a third time slot and
wherein the base station instructs the third mobile device to transmit data on the first time slot during another no-speech-data AMR frame of the first mobile device.

6. A wireless communication system according to claim 1 wherein the GPRS base station also instructs the second mobile device to receive data on the first time slot during another no-speech-data AMR frame of the first mobile device.

7. A method for a GPRS base station comprising:
receiving an AMR speech burst from a first mobile device on a first time slot;
receiving a silence descriptor first (F) AMR frame from the first mobile device on the first time slot; and
assigning the first time slot to a second mobile device, served by the GPRS base station and having a packet-switched connection, during no-speech-data (N) AMR frames of the first mobile device.

8. A method according to claim 7 further comprising:
receiving packet-switched data from the second mobile device using a 52-multiframe structure having at least one A-idle frame that allows the first mobile device to transmit an AMR Access Burst (AAB) to the GPRS base station.

9. A method according to claim 7 further comprising:
receiving an AMR Access Burst (AAB) from the first mobile device during an A-idle frame of a 52-multiframe structure.

10. A method according to claim 7 further comprising:
discontinuing the assigning of the first time slot to the second mobile device.

11. A method according to claim 7 further comprising:
receiving a speech (S) AMR frame from the first mobile device on the first time slot.

12. A method according to claim 7 further comprising:
transmitting packet-switched data to the second mobile device using a 52-multiframe structure having at least one A-idle frame that allows the first mobile device to transmit an AMR Access Burst (AAB) to the GPRS base station.

13. A method for a circuit-switched mobile device comprising:
transmitting a speech (S) adaptive multi-rate (AMR) frame;
transmitting a silence descriptor (SID) First (F) AMR frame; and
transmitting an AMR Access Burst (AAB) during an A-idle frame of a 52-multiframe structure.

14. A method according to claim 13 further comprising:
transmitting a no-speech-data (N) AMR frame, after transmitting the F AMR frame.

15. A method according to claim 14 further comprising:
transmitting a silence descriptor (SID) Update (U) AMR frame, after transmitting the N AMR frame.

16. A method according to claim 13 further comprising:
tracking the 52-multiframe after the transmitting the F AMR frame.

17. A method according to claim 13 wherein the AAB comprises:
initial tail bits with 3 modulating bits with states (0, 0, 0);
fixed bits with 142 modulating bits with states (0, 0 . . . , 0); and
final tail bits with 3 modulating bits with states (0, 0, 0).

18. A method according to claim 17 wherein the AAB further comprises:
at least one guard bit.

19. A method according to claim 13 wherein the AAB comprises:
initial tail bits with 3 modulating bits with states (0, 0, 0);
fixed bits with 142 modulating bits with states (1, 0, 1, 0, . . . , 1, 0); and
final tail bits with 3 modulating bits with states (0, 0, 0).

20. A method according to claim 19 wherein the AAB further comprises:
at least one guard bit.
